(19) United States
(12) Patent Application Publication
(10) Pub. No.: US 2005/0212941 A1
(43) Pub. Date: Sep. 29, 2005

(54) Image pickup apparatus

(75) Inventor: Hideo Yoshida, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJINON CORPORATION

(21) Appl. No.: 11/086,384

(22) Filed: Mar. 23, 2005

(30) Foreign Application Priority Data
Mar. 25, 2004 (JP) P.2004-088271

(51) Int. Cl. H04N 5/222

(52) U.S. Cl. 348/333.01

(57) ABSTRACT

An image pickup apparatus has a plurality of modes, at least one of the modes being a mode where an imaging process is conducted, wherein the apparatus comprises: a displaying portion that displays a state; and a mode switchover operating element that is switchable to select an arbitrary one of the modes, and wherein the mode switchover operating element comprises a light transmitting member that covers the displaying portion irrespective of a mode to which the mode switchover operating element is switched.

### BACKGROUND OF THE INVENTION

1. Field of the Invention

The present invention relates to an image pickup apparatus which has a plurality of modes, and in which at least one of the modes is a mode where an imaging process is conducted.

2. Background of the Invention

Many image pickup apparatuses such as cameras comprise a large number of operating elements. In order to produce a small camera which is easy to handle, as the number of operating elements is larger, the many operating elements must be arranged more adequately in a limited size. Some of such cameras are configured so that, when an operating element is operated, the operation contents are displayed on a display screen in order to enable the user to know the contents of the operation. The operation contents displayed on the screen helps the user to operate the camera, and hence it is preferable to increase the size of the display screen as much as possible. However, it is difficult to dispose such a large display screen together with a required number of operating elements on a small camera body.

Even in the case where the size of the display screen is increased so as to meet the request for a large screen, when an excessive amount of information is displayed on the screen, necessary information is hardly seen. Therefore, a technique has been proposed in which, in accordance with a switching operation on a mode switchover operating element in operating elements disposed on a camera body, display contents that are not required in the selected mode are covered by a mask member, so that only necessary information corresponding to the mode is clearly displayed on a display screen (for example, see Japanese Patent No. 3,370,425). However, the technique disclosed in Japanese Patent No. 3,370,425 is directed to assurance of easy viewing of a display screen, and does not contribute to size reduction.

In a digital camera or the like, there is a case where a screen for displaying an image is not used for displaying operation contents, and a displaying portion such as LEDs for displaying operation contents is additionally disposed. In such a case, it is difficult to dispose the displaying portion while maintaining the size of the screen for displaying an image. In most situations, therefore, the size of the screen for displaying an image is slightly reduced, or the number of operating elements is decreased, so that several LEDs or a small LCD can be disposed as a displaying portion. In such situations, a cross key or the like may be disposed so as to enable items on the screen to be selected, whereby the number of operating elements is decreased or LEDs are omitted. However, not a few people think that the user can handle a camera more easily in a configuration where operating elements are disposed respectively for items and the user is requested only to conduct one-touch operation on one of the operating elements. Even in a case where a cross key or the like is disposed, it is often that only operating elements which are particularly necessary are additionally disposed together with LEDs or the like for displaying operation contents.

FIG. 1 shows a hybrid camera which comprises both a digital camera and a film camera.

On the back face of the body of the camera 20 shown in FIG. 1, disposed are an LCD panel 21 which has a size of a degree that can assure easy viewing, a mode dial 22 which has a size of a degree that can assure easy operation, and four LEDs 24 which serve as a displaying portion for displaying contents of an operation. Since the camera shown in FIG. 1 is a hybrid camera, also a film loading check window (hereinafter, referred to as CC window) 23 is disposed in the back face of the camera body.

In layout design of the back face of the body of such a camera, the components each having a minimum required size are arranged on the back face. Because of restrictions on the external shape of the camera body, however, there may inevitably arise a case where, even though the operability or easy viewing is somewhat reduced, at least one of the LCD panel 21, the operating element 22, the LEDs 24, and the CC window 23 must be replaced with a component having a size which is slightly smaller.

### SUMMARY OF THE INVENTION

In view of the above-discussed circumstances, it is an object of the invention to provide a camera (image pickup apparatus) in which it is not required to replace components that are to be disposed on the surface of the camera, such as a displaying portion, a display screen, operating elements, and a CC window, with those having a size which is slightly smaller.

A first camera of the invention which attains the object is a camera which has a plurality of modes, at least one of the modes being a mode where an imaging process is conducted, wherein the camera comprises: a displaying portion that displays a state; and a mode switchover operating element that is switchable to select an arbitrary one of the modes, and wherein the mode switchover operating element comprises a light transmitting member that covers the displaying portion irrespective of a mode to which the mode switchover operating element is switched.

According to the camera of the invention, the displaying portion is placed in a state where the portion is covered by the mode switchover operating element formed by the light transmitting member. Therefore, at least part of the operating element can be placed to overlap with the displaying portion. The space where the operating element overlaps with the displaying portion produces a dimensional latitude. Because of this latitude, it is possible to realize a camera in which it is not required to replace the mode switchover operating element and the displaying portion with those having a size which is slightly smaller.

A second camera of the invention which attains the object is a camera which has a plurality of modes, at least one of the modes being a mode where an imaging process is conducted,
wherein the camera comprises: a mode switchover operating element that is switchable to select an arbitrary one of the modes; and a displaying portion that conducts a display having a meaning in only a first mode of the modes, and
wherein the mode switchover operating element comprises a check window that overlaps with the displaying portion when the mode switchover operating element is switched to the first mode.

In the second camera of the invention, the check window which overlaps with the displaying portion when the mode switchover operating element is switched to the predetermined mode (the first mode) enables a display having a meaning in only the predetermined mode, to be viewed through the check window. In the first camera, the display of the displaying portion is viewed through the mode switchover operating element formed by the light transmitting member which covers the displaying portion irrespective of the mode to which the mode switchover operating element is switched. By contrast, also in a configuration where, as in the second camera, the check window is formed in the mode switchover operating element to enable the display to be viewed only in the predetermined mode, it is possible to attain the same effect as that in the first camera.

In the second camera, information related to modes other than the predetermined mode is hidden, so that unnecessary information is not displayed and only necessary information is displayed to be informed to the user. Therefore, the operability of the camera is improved.

In the second camera, preferably, the camera further comprises a film compartment into which a photographic film is to be loaded; and an image pickup device, wherein the first mode is a mode where the imaging process is conducted on the photographic film loaded, and a second mode of the modes is a mode where image data indicating an object is produced with the image pickup device, the second mode being different from the first mode, and wherein the displaying portion comprises a film loading check window for checking whether the photographic film is loaded into the film compartment or not.

According to the configuration, in a state where the mode switchover operating element is switched to the first mode, the film loading check window serving as the displaying portion overlaps with the check window. Only when the imaging process is to be conducted on a photographic film in the state where the mode switchover operating element is switched to the first mode, therefore, it is possible to check whether a photographic film is loaded or not, through the film loading check window. As a result, only necessary information can be informed to the user when necessary.

### BRIEF DESCRIPTION OF THE DRAWINGS

FIG. 1 is a view showing an example in which a display screen and an operating element are placed on the back face of a camera body;

FIGS. 2A to 2C are views showing the appearance of a hybrid camera which is a first embodiment of the invention;

FIG. 3 is a block diagram showing the internal configuration of the hybrid camera of FIGS. 2A to 2C;

FIG. 4 is a view showing only a mode dial and an LCD panel in FIG. 2C so that they can be compared with those in FIG. 1;

FIG. 5 is a view showing another embodiment;

FIG. 6 is a view showing only a mode dial in FIG. 5; and

FIG. 7 is a view showing an example in which the mode dial of FIGS. 5 and 6 is applied to a slide switch 200.

### DETAILED DESCRIPTION OF THE INVENTION

Hereinafter, embodiments of the invention will be described with reference to the accompanying drawings.

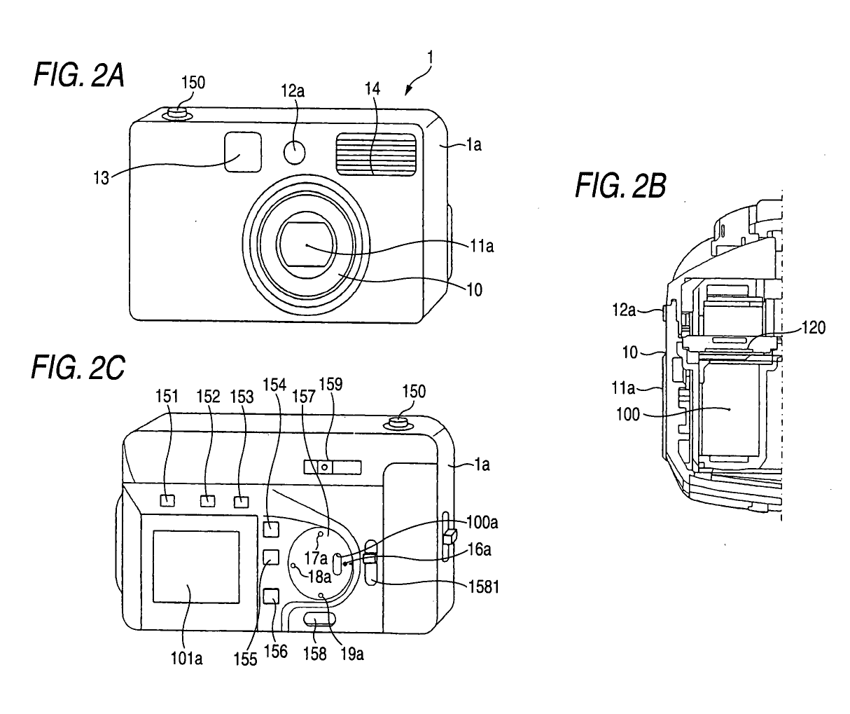

FIGS. 2A to 2C are views showing the appearance of a hybrid camera which is a first embodiment of the invention.

The hybrid camera 1 comprises both a digital camera (hereinafter, referred to as DSC) and a film camera, and can take also motion pictures.

FIG. 2A is a front view, FIG. 2B is a section view taken long the center line of FIG. 2A, as viewed from a lateral side, and FIG. 2C is a rear view.

As shown in FIG. 2A, a lens mount 10 is disposed at the middle of the camera body, and an imaging lens 11a for the film camera is incorporated in the lens mount. An imaging lens 12a for the DSC is disposed above the lens mount 10. A finder 13 and a flash emission window 14 are disposed on both sides of the imaging lens 12a for the DSC, respectively. A shutter release button 150 is placed on the upper face of the camera body. When the release button 150 is operated, imaging instructions are transmitted to an internal controlling section.

In this way, the hybrid camera 1 comprises independently a first imaging optical system for the film camera, and a second imaging optical system for the DSC.

FIG. 2B is a section view of the lens mount as viewed from a lateral side, and showing the positional relationship between a film cartridge 100 loaded into a medium compartment and an image pickup device 120. A photographic film which is wound in the cartridge 100 loaded into the medium compartment is drawn out by a feed motor (not shown), and an imaging frame is set to an imaging plane. An object image is formed on the set imaging frame by the imaging lens 11a disposed in the first imaging optical system, and an object image which is identical with the object image is formed on the image pickup device 120 by the imaging lens 12a disposed in the second imaging optical system.

In a back portion shown in FIG. 2C, a mode switchover operating element 157, various switch groups, and an LCD panel 101a on which a framing image captured by the imaging lens 12a in the second imaging optical system is to be displayed are arranged.

An operating element 151 for instructing ON/OFF of the display screen, a menu button 152 for displaying a menu on the LCD panel 101a, and an OK button 153 for designating a selected item when the selection menu is displayed are arranged above the LCD panel 101a to constitute a switch group. Furthermore, UP and DOWN keys 154 and 155 for changing a selected item displayed on the LCD panel 101a are arranged on the right side of the LCD panel 101a, and a flash switchover button 156 is disposed below the keys. When the flash switchover button 156 is operated, one of flash modes such as a program flash mode and a red-eye-reduction flash mode is designated.

A mode dial 157 is placed adjacent to the UP key 154 and the DOWN key 155, and a power switch 158 is placed below the mode dial 157. The hybrid camera shown in FIGS. 2A to 2C has four modes of a DSC mode, a film mode, a motion picture mode, and a play mode. The mode dial 157 corresponds to the mode switchover operating element in the invention. Among the modes, the film mode corresponds to the first mode in the invention, and the DSC mode or the motion picture mode corresponds to the second mode in the invention. The mode dial 157 is formed by a light transmitting member. When the mode dial 157 is switched to one of the modes, one of LEDs 16a to 19a which, in the embodiment, serve as a displaying portion placed on the surface of the camera body 1a so as to overlap with the mode dial 157 lights up to inform the photographer of the selected mode. FIG. 2C shows a state where the mode dial 157 is switched to the film mode.

When the mode dial 157 is switched to the film mode, the LED 16a lights up to inform the photographer that the selected mode is the film mode, and an imaging process using the first imaging optical system is prepared. At this time, as described above, a framing image captured by the second imaging optical system is displayed on the LCD panel 101a, so that the photographer can conduct an imaging process while viewing the framing image or while looking through the finder. In the hybrid camera 1, a film loading check window (hereinafter, referred to as CC window) 100a for checking whether a photographic film is loaded or not is opened in the camera body, so that an operation of checking whether a photographic film is loaded or not can be conducted at any time.

In this way, it is checked through the mode switchover operating element and the CC window whether a photographic film is loaded or not, and a framing operation is conducted based on the framing image. When the shutter button 150 is depressed at the right moment, an object image is formed on the photographic film by the imaging lens 11a of the first imaging optical system. In the hybrid camera 1, an object image which is identical with the object image captured by the imaging lens 11a of the first imaging optical system is formed on the light-sensitive surface of the image pickup device 120 by the imaging lens 12a of the second imaging optical system, and an aperture/shutter module disposed in the first imaging optical system 11 is driven on the basis of brightness information in image data produced by the image pickup device 120, so that an object image is formed at an optimum light amount on the imaging frame of the photographic film. When the mode dial 157 is switched to the DSC mode or the motion picture mode, the LED 17a or 18a lights up to inform the photographer that the selected mode is the DSC mode or the motion picture mode. In these modes, the aperture/shutter module disposed in the first imaging optical system is not driven, image data are produced by the image pickup device 120 at the timing when the shutter button 150 is depressed, and the image data are recorded into a memory card.

A zoom lens is disposed in the imaging lens 11a of the first imaging optical system. The focal length of the zoom lens is changed by operating a zoom switch 159 which is placed above the mode dial 157. A back-cover release knob 1581 which is to be operated in replacement of the film is disposed beside the mode dial 157.

When the mode dial 157 is switched to the play mode, the LED 19a lights up to inform the photographer that the selected mode is the play mode, and an image based on image data which were obtained at the latest time among those stored in the memory card is displayed on the LCD panel 101a. When the UP key 154 or the DOWN key 155 is operated, images based on other image data are sequentially displayed on the LCD panel 101a.

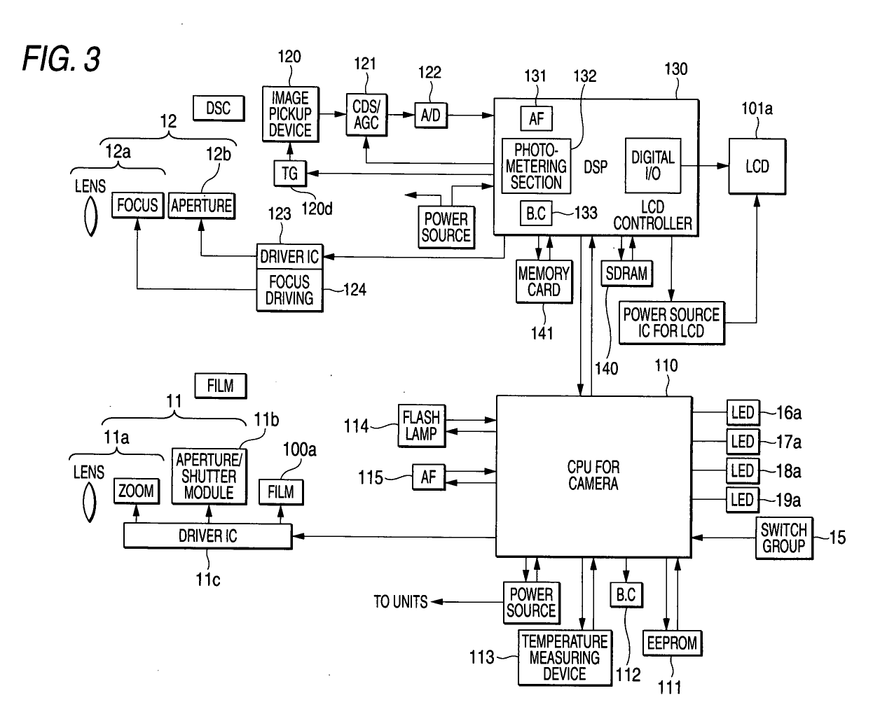

FIG. 3 is a block diagram showing the internal configuration of the hybrid camera of FIGS. 2A to 2C.

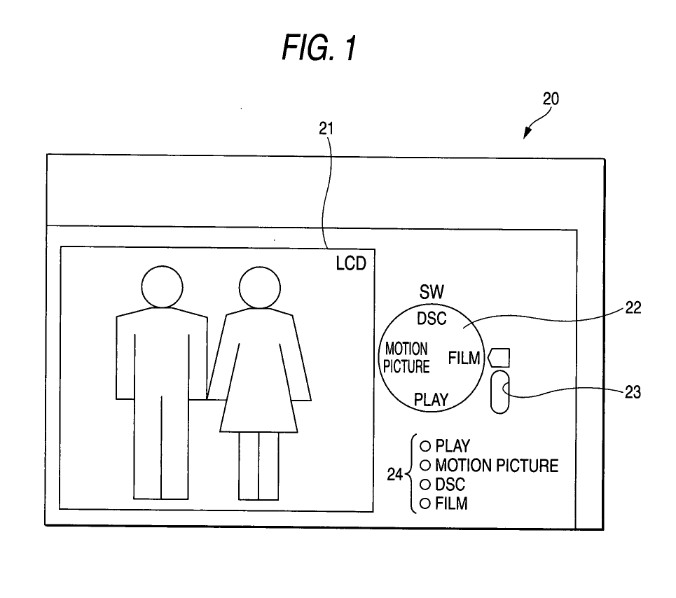

As shown in FIG. 3, a CPU 110 and a DSP 130 cooperate to control operations of the whole hybrid camera 1 of FIG. 1. Programs are stored in an EEPROM 111 on the side of the CPU 110. On the basis of the programs, the CPU 110 implements processes of controlling the operations of the whole hybrid camera.

As shown in FIG. 3, the CPU 110 controls the first imaging optical system on the side of the film camera, and the DSP 130 which receives instructions from the CPU 110 controls the second imaging optical system on the side of the DSC.

The first imaging optical system 11 on the side of the film camera comprises: the imaging lens 11a including a focusing lens and the zoom lens; and the aperture/shutter module 11b which adjusts the light amount to be applied to the film. The second imaging optical system 12 on the side of the DSC comprises: the imaging lens 12a including a focusing lens; and an aperture 12b.

First, operations in the case where the mode dial is switched to the DSC mode which is the second mode will be briefly described.

When the mode dial 157 is switched to the DSC mode, the LED 17a lights up to inform the photographer that the selected mode is the DSC mode. At the same time when the mode dial 157 is switched to the DSC mode, the imaging process is prepared so that the process can be conducted on the side of the DSC.

The configuration and operation of the DSC will be briefly described.

On the side of the DSC, a CMOS sensor is disposed as the image pickup device 120. A CDS (Correlated Double Sampling) which reduces the noise level, and an AGC (Auto Gain Control) which controls the amplitude are disposed in the stage subsequent to the image pickup device 120.

In the image pickup device 120, RGB signals are produced on the basis of the object image which is formed on a light receiving portion, i.e., the light-sensitive surface by the second imaging optical system 12, and the produced RGB signals are supplied to the CDS/AGC 121 at predetermined intervals (for example, 33 ms) in accordance with a timing signal output from a TG (Timing Generator). By the CDS/AGC 121, noises are removed away and the amplitudes are adjusted. The RGB signals in which noises are removed away and the amplitudes are adjusted are supplied to an A/D section 122 to be converted to digital signals. The digitized RGB signals are supplied to the DSP 130, and adequate image processing is applied on the RGB signals. Based on the RGB signals, photometering is conducted by a photometering section 132, and the object distance is measured by a range finder (hereinafter, referred to as AF) 131. In the distance measurement by the AF 131, the focusing lens must be moved. Therefore, a focus driving section 124 is disposed. The aperture must be driven in accordance with a result of the photometering by the photometering section, and hence also a driver IC 123 is disposed.

The digitized RGB signals of one screen are once stored into an SDRAM 140, and then passed through a digital I/O and an LCD controller which are incorporated in the DSP, so that the pixel arrangement pattern of RGB is changed to a format corresponding to the LCD panel 101a. Then, the signals are transferred to the LCD panel 101a. The digitized RGB signals of one screen are updated at intervals of 33 ms. At each updating, the image displayed on the LCD panel 101a is switched over so that images of an object are displayed as if they are motion picture images. The imaging process is conduced while using the image as a framing image.

Next, the imaging process in the DSC mode or the motion picture mode will be described.

When the shutter button 150 is depressed in a state where a framing image is displayed, a timing signal indicative of instructions for starting exposure is supplied from the TG 120d at the timing when the shutter button 150 is depressed, and, after an elapse of a predetermined time period, a signal indicative of instructions for ending the exposure is supplied from the TG. When the signal indicative of instructions for ending the exposure is supplied to the image pickup device 120 after an elapse of a predetermined time period from the start of the exposure, RGB signals in the image pickup device 120 are output to the CDS/AGC 121 to be supplied toward the DSP 130, and all the RGB signals supplied to the DSP 130 are once stored into the SDRAM 140. Thereafter, the RGB signals are read out and converted to YUV signals by the DSP 130. The YUV signals are compressed, and a header is added to image data configured by the compressed YUV signals to form an image file, so that the image data are stored into the memory card. In the motion picture mode, a series of image data which are read out at intervals of 33 ms from the image pickup device are stored as motion picture data into the memory card. The DSP 130 further incorporates a battery check (hereinafter, referred to as BC) 133, and the like.

Next, operations in the case where the mode dial 157 is switched to the film mode which is the first mode will be described.

When the mode dial 157 is switched to the film mode, the LED 16a lights up to inform the photographer that the selected mode is the film mode.

In the hybrid camera 1, even when the mode dial 157 is switched to the film mode, the framing image which is produced in the DSC remains to be displayed on the display screen. Therefore, the imaging process can be conducted by applying a framing operation on the framing image and then depressing the shutter button 150.

When the shutter button 150 is depressed in this way, the CPU 110 drives the aperture/shutter module 11b so that the imaging process is conducted on the photographic film. In the driving of the aperture/shutter module 11b, the photometric value obtained in the photometering section 132 in the DSC is transmitted from the DSP 130 to the CPU 110, and the opening of the aperture/shutter module 11b of the first imaging optical system 11 is controlled. The aperture/shutter module 11b is a program shutter. In order to enable the aperture/shutter module 11b to operate as a program shutter, combinations of an aperture and a shutter speed which are required for driving the aperture/shutter module 11b as the program shutter are previously recorded as aperture values into the EEPROM 111. In accordance with the photometric value measured by the photometering section 132 in the DSC, the CPU 110 reads out one of the aperture values, and supplies the aperture value to a driver IC 11c. The driver IC 11c drives the opening of the aperture/shutter module 11b to the maximum opening angle as time elapses so as to attain the aperture value, and, after a predetermined time period elapses, closes the aperture/shutter module.

In the lower left portion of FIG. 3, a driving section which drives the zoom lens in the imaging lens 11a of the first imaging optical system 11, the aperture/shutter module 11b of the first imaging optical system 11, and the feed motor that feeds the photographic film is indicated as the single driver IC 11c.

The hybrid camera 1 further comprises a temperature measuring device 113. In accordance with the temperature measured by the temperature measuring device, and the aperture value, the light emission time of a flash lamp 114 and the like are finely controlled. AFs 131, 115 which measure the object distance are disposed in both the DSC and film sides in order to correct their measured values of the object distance.

In the thus configured hybrid camera, the CPU 110 controls also lighting of the displaying portion configured by the four LEDs 16a to 19a.

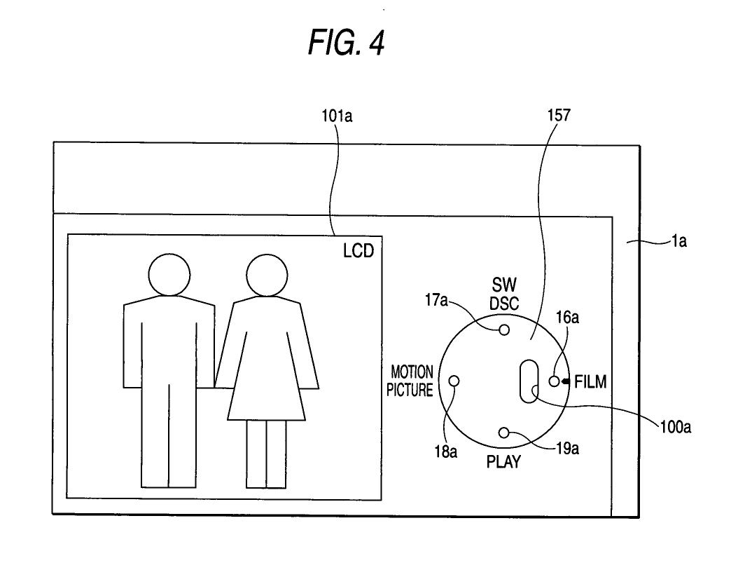

FIG. 4 shows only the mode dial and the LCD panel in FIG. 2C so that they can be compared with those in FIG. 1. Although the switch groups are shown in FIG. 2C, FIG. 4 shows the back face of the camera body in which only the LCD panel 101a and the mode dial 157 are indicated, thereby enabling the sizes of the mode dials in FIGS. 1 and 4 to be compared with each other.

The four LEDs 16a to 19a of the displaying portion are located at positions which correspond to the film mode, the DSC mode, the motion picture mode, and the play mode, respectively. When the mode dial 157 is switched to one of the modes, corresponding one of contacts of the mode dial 157 is connected, and a signal is supplied from the connected contact to the CPU 110 (see FIG. 3). The CPU 110 receives the signal, and supplies a lighting signal to one of the LEDs 16a to 19a which corresponds to the contact, so that the one of the LEDs 16a to 19a to which the lighting signal is supplied lights up. As a result of the lighting, the photographer is informed of the selected mode. Moreover, it is possible to check at any time whether a photographic film is loaded or not, through the mode dial 157 formed by a light transmitting member, and the CC window 100a.

When FIGS. 1 and 4 are compared with each other, it will be seen that the configuration where the LEDs 16a to 19a serving as a displaying portion, and the CC window 100a are placed so as to overlap with the mode dial 157 formed by a light transmitting member enables both the components to be disposed on a compact camera body even when the size of the mode dial 157 is increased.

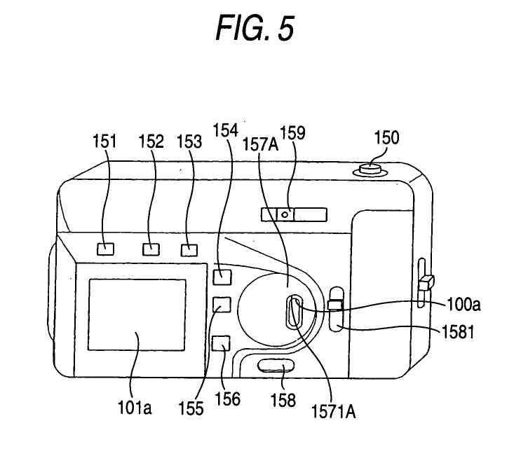

FIG. 5 is a view showing another embodiment.

The embodiment has the same configuration as that shown in FIGS. 2A to 2C except that a mode dial 157A is configured in a different manner.

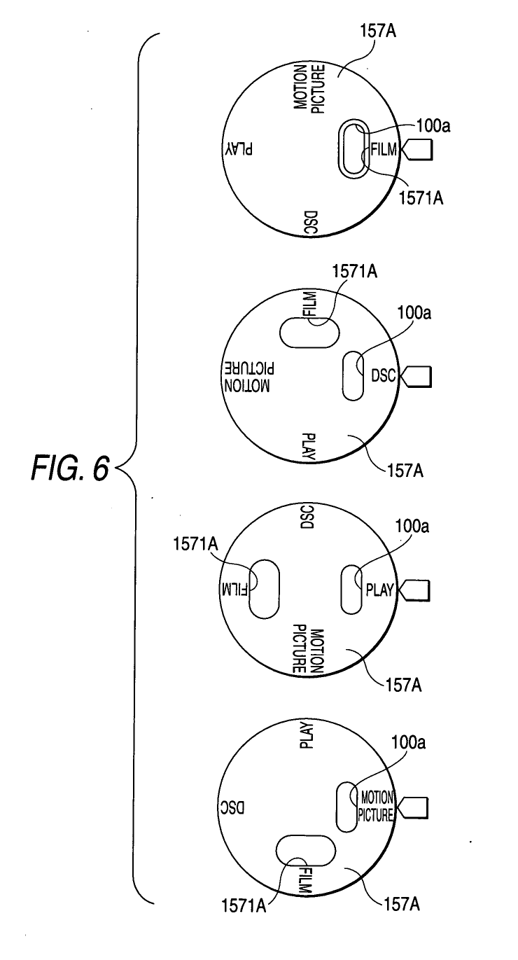

FIG. 6 is a view showing only the mode dial in FIG. 5.

FIG. 6 shows the embodiment where the displaying portion in the invention which conducts a display having a meaning in only a predetermined mode is formed as a film loading check window.

As shown in FIG. 6, the mode dial 157A having the film mode, the DSC mode, the motion picture mode, and the play mode has a check window 1571A which, in a state where the mode dial is switched to the film mode, overlaps with a displaying portion, or, in the embodiment, the CC window 100a opened in the camera body. Only when the mode dial 157A is switched to the film mode, the check window 1571A overlaps with the CC window 100a to enable the photographer to check whether a photographic film is loaded or not.

In the case where it is not required to conduct a display when the mode dial 157A is switched to a mode other than the film mode, the above configuration may be employed. When compared with FIG. 1, it will be seen that the mode dial 157A in which the size is increased by a degree corresponding to the overlapping with the CC window 100a is disposed. It is possible to attain another effect that information related to modes other than the predetermined mode is hidden and only necessary information is informed to the operator.

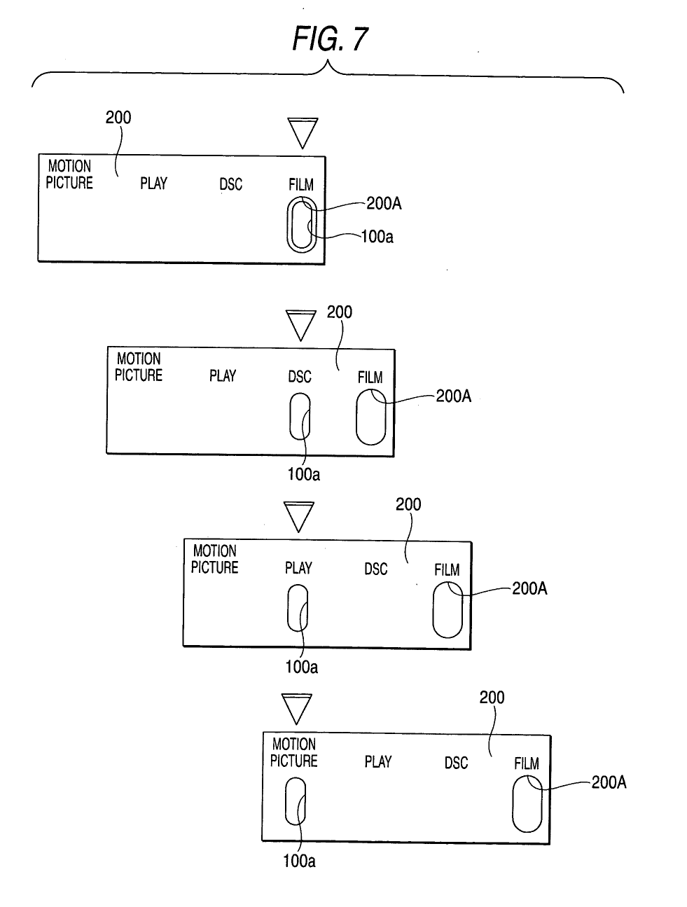

FIG. 7 shows an example in which the configuration of the mode dial of FIGS. 5 and 6 is applied to a slide switch 200.

The configuration of FIG. 5 can be applied to such a slide switch 200. In the case where there is a space corresponding to the width and length of the slide switch 200, when a check window 200A overlaps with the slide switch 200 and the CC window 100a, the CC window 100a functions as a displaying portion so that it is possible to visually check whether a photographic film is loaded or not, through the check window 200A and the film loading check window 100a.

In the above, the invention has been described with taking a hybrid camera as an example. Alternatively, the image pickup apparatus may be a digital camera, a single-lens reflex camera, or the like. The example in which the predetermined mode is the film mode and the displaying portion which conducts a display having a meaning in only the film mode is the film loading check window has been described. Various displaying portions may be employed as the displaying portion which conducts a display having a meaning in a predetermined mode. In the case where the predetermined mode is the flash mode, for example, information having a meaning in only the flash mode may be that indicating whether a power necessary for flash light is charged in a main capacitor or not.

As described above, it is possible to realize a camera in which an operating element formed by a light transmitting member is disposed so as to overlap with LEDs of a displaying portion, and, even when a dedicated operation displaying portion is disposed, the display screen and the operating element are not requested to be reduced in size. Moreover, it is possible to realize a camera which has a mode dial having a size that is increased by a degree corresponding to a space where LEDs are conventionally disposed, and which is therefore easy to operate.

As described above, it is possible to realize a camera in which it is not required to replace components that are to be disposed on the surface of the camera, such as a displaying portion, a display screen, operating elements, and a CC window, with those having a size which is slightly smaller.

The entire disclosure of each and every foreign patent application from which the benefit of foreign priority has been claimed in the present application is incorporated herein by reference, as if fully set forth.

1. An image pickup apparatus which has a plurality of modes, at least one of the modes being a mode where an imaging process is conducted,
wherein the apparatus comprises: a displaying portion that displays a state; and a mode switchover operating element that is switchable to select an arbitrary one of the modes, and
wherein the mode switchover operating element comprises a light transmitting member that covers the displaying portion irrespective of a mode to which the mode switchover operating element is switched.

2. An image pickup apparatus which has a plurality of modes, at least one of the modes being a mode where an imaging process is conducted,
wherein the apparatus comprises: a mode switchover operating element that is switchable to select an arbitrary one of the modes; and a displaying portion that conducts a display having a meaning in only a first mode of the modes, and
wherein the mode switchover operating element comprises a check window that overlaps with the displaying portion when the mode switchover operating element is switched to the first mode.

3. An image pickup apparatus according to claim 2, further comprising:
a film compartment into which a photographic film is to be loaded; and
an image pickup device,
wherein the first mode is a mode where the imaging process is conducted on the photographic film loaded, and a second mode of the modes is a mode where image data indicating an object is produced with the image pickup device, the second mode being different from the first mode, and
wherein the displaying portion comprises a film loading check window for checking whether the photographic film is loaded into the film compartment or not.
